(19) United States
(12) Patent Application Publication
(10) Pub. No.: US 2025/0309651 A1
(43) Pub. Date: Oct. 2, 2025

(54) SERVER APPARATUS, POWER CONTROL SYSTEM, AND POWER CONTROL METHOD

(71) Applicant: TOYOTA JIDOSHA KABUSHIKI KAISHA, Aichi-ken (JP)

(72) Inventors: Shigeyuki URANO, Mishima-shi (JP); Yusuke ONDA, Tokyo-to (JP); Kentaro BAN, Tokyo-to (JP)

(21) Appl. No.: 19/083,435

(22) Filed: Mar. 19, 2025

(30) Foreign Application Priority Data
Mar. 27, 2024 (JP) 2024-052124

(51) Int. Cl. H02J 3/32; H02J 3/00; H02J 7/00

(52) U.S. Cl. CPC H02J 3/32; H02J 3/003; H02J 7/0063

(57) ABSTRACT

A server apparatus communicates with another server apparatus. The other server apparatus directs a first operation amount to a power load in a jurisdiction to consume power that can be consumed by the load, based on predicted power demand by the power load and an actual power generation record of the amount of power generated to be supplied to the load, and change the first amount to a second operation amount based on an actual power consumption record consumed by the load. The server apparatus sends out a discharge instruction to cause a storage battery to discharge power to be further supplied to the load, based on a power purchase amount, which is determined by the other apparatus, to be further purchased from a system in order to be supplied to the load, the first amount, the power consumption record, and the power generation record.

### CROSS-REFERENCE TO RELATED APPLICATION

This application claims priority to Japanese Patent Application No. 2024-052124, filed on Mar. 27, 2024, the entire contents of which are incorporated herein by reference.

### TECHNICAL FIELD

The present disclosure relates to a server apparatus, a power control system, and a power control method.

### BACKGROUND

The concept of a community energy management system (Community EMS or CEMS), which manages, as a whole, power generation by power generation facilities distributed in a community, power supply from a power system of a power provider, and power demand occurring within the community, is being developed in communities managed by municipalities, companies, and the like. Various technologies have been proposed to predict power consumption in a community so that electric power matching power demand in the community can be supplied. Patent Literature (PTL) 1 discloses a system that controls power supply based on predicted power.

### CITATION LIST

### Patent Literature

PTL 1: WO 2019/116960 A1

### SUMMARY

There is room for improvement in the tracking accuracy of power supply when additional power supply is required to meet sudden fluctuations in power supply and demand.

The present disclosure relates to a server apparatus and the like that can improve the tracking accuracy of additional power supply to meet fluctuations in power supply and demand in a community.

A server apparatus according to the present disclosure includes:
a communication interface; and
a controller configured to communicate by the communication interface with another server apparatus configured to direct a first operation amount to a power load in a jurisdiction to consume power that can be consumed by the power load, based on predicted power demand by the power load and an actual power generation record of the amount of power generated to be supplied to the power load, and change the first operation amount to a second operation amount based on an actual power consumption record consumed by the power load,
wherein the controller is configured to send out a discharge instruction to cause a storage battery to discharge power to be further supplied to the power load, based on a power purchase amount to be further purchased from a system in order to be supplied to the power load, the first operation amount, the actual power consumption record, and the actual power generation record, the power purchase amount being determined by the other server apparatus.

A system according to the present disclosure is a power control system having a plurality of server apparatuses configured to be communicably connected, the power control system including:
a first server apparatus configured to direct a first operation amount to a power load in a jurisdiction to consume power that can be consumed by the power load, based on predicted power demand by the power load and an actual power generation record of the amount of power generated to be supplied to the power load, and change the first operation amount to a second operation amount based on an actual power consumption record consumed by the power load; and
a second server apparatus configured to send out a discharge instruction to cause a storage battery to discharge power to be further supplied to the power load, based on a power purchase amount to be further purchased from a system in order to be supplied to the power load, the first operation amount, the actual power consumption record, and the actual power generation record, the power purchase amount being determined by the first server apparatus.

An operation method of a system according to the present disclosure is a power control method by a plurality of server apparatuses configured to be communicably connected, the power control method including:
directing, by a first server apparatus, a first operation amount to a power load in a jurisdiction to consume power that can be consumed by the power load, based on predicted power demand by the power load and an actual power generation record of the amount of power generated to be supplied to the power load;
changing, by the first server apparatus, the first operation amount to a second operation amount based on an actual power consumption record consumed by the power load; and
sending out, by a second server apparatus, a discharge instruction to cause a storage battery to discharge power to be further supplied to the power load, based on a power purchase amount to be further purchased from a system in order to be supplied to the power load, the first operation amount, the actual power consumption record, and the actual power generation record, the power purchase amount being determined by the first server apparatus.

A server apparatus and the like according to the present disclosure can improve the tracking accuracy of additional power supply to meet fluctuations in power supply and demand in a community.

### BRIEF DESCRIPTION OF THE DRAWINGS

In the accompanying drawings:

FIG. 1 is a diagram illustrating an example of a configuration of a CEMS;

FIG. 2 is a diagram illustrating an example of a configuration of a server apparatus;

FIG. 3 is a diagram illustrating an example of operations of the server apparatus; and

FIG. 4 is a diagram illustrating an example of the operations of the server apparatus.

### DETAILED DESCRIPTION

An embodiment will be described below.

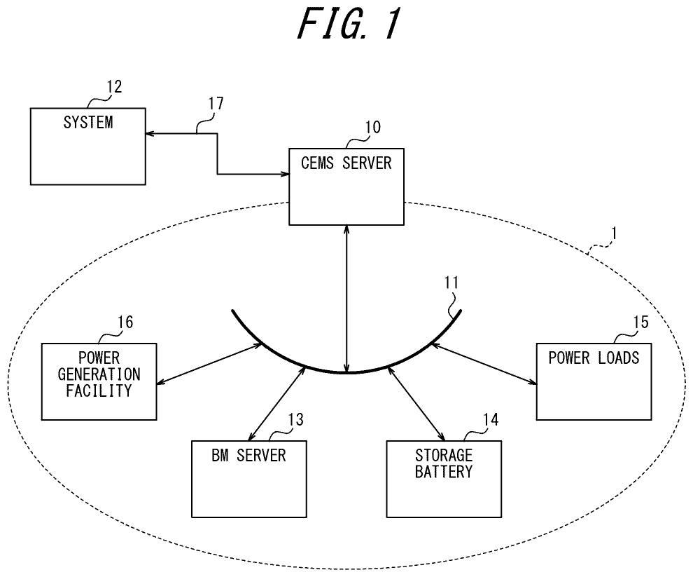

FIG. 1 is a diagram illustrating an example of a configuration of a CEMS according to the embodiment. In this CEMS, a CEMS server 10 manages power supply and demand in a community 1. As used below, a community is any town or regional unit managed by a municipality, company, or the like. The CEMS server 10 is communicably connected to at least one storage battery management server (hereinafter referred to as BM server) 13, at least one storage battery 14, one or more power loads 15, and at least one power generation facility 16, via a network 11. The CEMS server 10 is also communicably connected to a system 12 via a network 17. The CEMS server 10 executes information processing to instruct the power generation facility 16 to generate power or to purchase (buy) power from the system 12, according to power demand by the power loads 15 distributed in the community 1. With operations of such a CEMS server 10, the power loads 15 receive power supply from the power generation facility 16 and the system 12. The BM server 13 is in conjunction with the CEMS server 10, and controls operations of the storage battery 14 to additionally supply power to the power loads 15. The storage battery 14 and the power generation facility 16 may be located inside the community 1 or outside the community 1.

The CEMS server 10 and the BM server 13 are, for example, server computers that belong to a cloud computing system or another type of computing system. The networks 11 and 17 are, for example, the Internet, ad-hoc networks, LANs, metropolitan area networks (MANs), other networks, or a combination of any of these. The power loads 15 are, for example, electric appliances, lighting fixtures, air conditioners, and the like installed in residences, commercial facilities, and the like. The power loads 15 may include battery electric vehicles (BEVs) and charging and discharging facilities thereof. The storage battery 14 is a large storage battery for stationary use, such as a lithium-ion battery or a nickel-metal hydride battery and a control apparatus thereof. The power generation facility 16 is, for example, a power generation apparatus using alternative energy, such as solar power or wind power, and a control apparatus thereof, or any type of fuel cell and a control apparatus thereof.

In the present embodiment, the BM server 13 corresponds to “server apparatus”. The BM server 13 communicates with another server apparatus, i.e., the CEMS server 10 that directs a first operation amount (hereinafter referred to as planned operation amount) to the power loads 15 in a jurisdiction, i.e., the community 1 to consume power that can be consumed by the power loads 15, based on predicted power demand by the power loads 15 and an actual power generation record of the amount of power generated to be supplied to the power loads 15, and changes the planned operation amount to a second operation amount (hereinafter referred to as corrected operation amount), based on an actual power consumption record consumed by the power loads 15. The BM server 13 sends out a discharge instruction to cause the storage battery 14 to discharge power to be further supplied to the power loads 15, based on a power purchase amount, which is determined by the CEMS server 10, to be further purchased from the system 12 in order to be supplied to the power loads 15, the planned operation amount, the actual power consumption record, and the actual power generation record. When power to be consumed by the power loads 15 is provided, there may be required additional power supply caused by a sudden increase in power demand by the power loads 15, a sudden decrease in the amount of power generated by the power generation facility 16 due to a sudden change in weather conditions, or the like. Even when an additional power generation facility 16 is operated to meet such additional power supply, it takes a certain amount of time to start up the power generation facility 16, which may fail to quickly track the sudden change in power demand. In addition, additional unplanned power purchase from the system 12 may result in an increase in cost, such as a penalty. According to the above operations of the BM server 13, the storage battery 14, which is more responsive than the power generation facility 16, can provide additional power supply. Therefore, it is possible to improve the tracking accuracy of additional power supply.

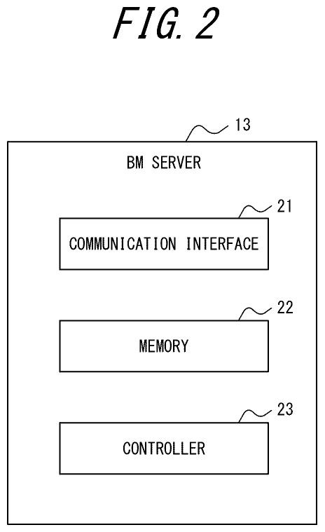

FIG. 2 illustrates an example of a configuration of the BM server 13. The BM server 13 includes a communication interface 21, a memory 22, and a controller 23. The BM server 13 may be a single server computer, or may be two or more computers that are communicably connected to each other and operate in cooperation. In the case of the two or more computers, the configuration illustrated in FIG. 2 can be arranged as appropriate among the two or more computers.

The communication interface 21 includes one or more interfaces for communication. The interfaces for communication include, for example, a LAN interface. The communication interface 21 receives information to be used for operations of the BM server 13 and transmits information obtained by the operations of the BM server 13. The BM server 13 is connected to the network 11 by the communication interface 21 and communicates information with the CEMS server 10, the storage battery 14, the power loads 15, the power generation facility 16, and the like via the network 11.

The memory 22 includes, for example, one or more semiconductor memories, one or more magnetic memories, one or more optical memories, or a combination of at least two of these types, to function as main memory, auxiliary memory, or cache memory. The semiconductor memories are, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 22 stores information to be used for the operations of the BM server 13 and information obtained by the operations of the BM server 13.

The controller 23 includes one or more processors, one or more dedicated circuits, or a combination thereof. The processors are general purpose processors, such as central processing units (CPUs), or dedicated processors, such as graphics processing units (GPUs), specialized for particular processes. The dedicated circuits are, for example, field-programmable gate arrays (FPGAs), application specific integrated circuits (ASICs), or the like. The controller 23 executes information processing related to the operations of the BM server 13 while controlling components of the BM server 13.

The functions of the BM server 13 are realized by a processor included in the controller 23 executing a control program. The control program is a program for causing a computer to execute the processing of steps included in the operations of the BM server 13, thereby enabling the computer to realize the functions corresponding to the processing of the steps. That is, the control program is a program for causing a computer to function as the BM server 13. Some or all of the functions of the BM server 13 may be realized by a dedicated circuit included in the controller 23. The control program may be stored on a non-transitory recording/storage medium readable by the BM server 13, and be read from the medium by the BM server 13.

The description of the configuration in FIG. 2 is also applied to the CEMS server 10.

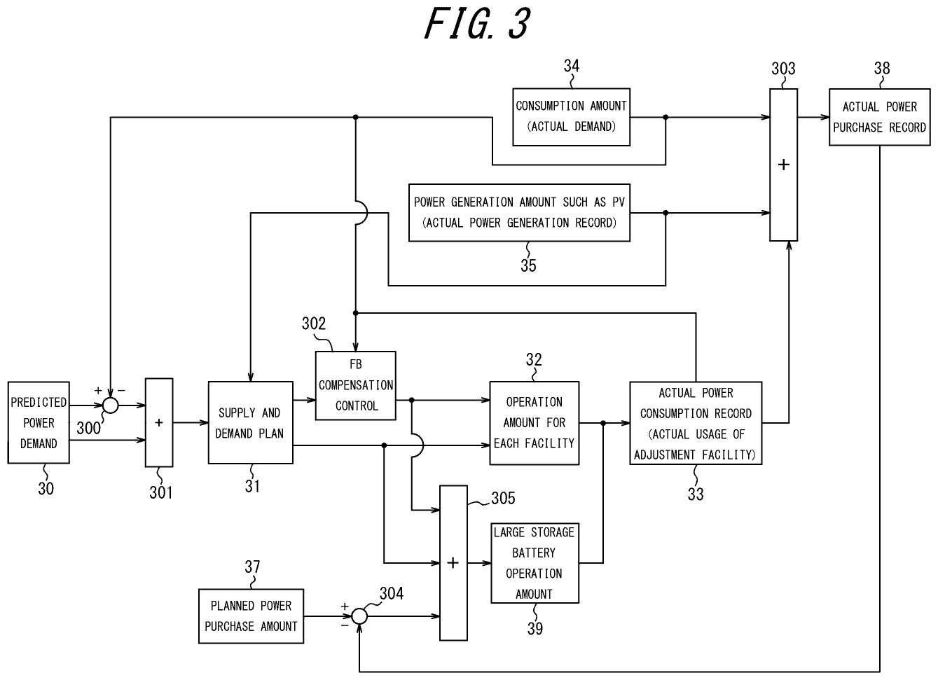

FIG. 3 is a diagram illustrating an operation procedure performed by the BM server 13 in conjunction with the CEMS server 10. FIG. 3 schematically illustrates a flow of information in control operations of the CEMS server 10 and the BM server 13. The CEMS server 10 performs a feed-forward process and a feed-back process to manage and control power supply and demand in the community 1. The BM server 13 performs an adjustment process to additionally supply power to the community 1.

The CEMS server 10 performs the feed-forward process in arbitrary cycles, e.g., every few hours. In the feed-forward process, the CEMS server 10 creates a supply and demand plan 31, based on predicted power demand 30 by the power loads 15 and an actual power generation record 35 of the amount of power generated to be supplied to the power loads 15. The supply and demand plan 31 includes information on electrical energy to be consumed by the power loads 15 and electrical energy that should be supplied to the power loads 15. The CEMS server 10 creates, by an arbitrary algorithm, the predicted power demand 30 that takes into account seasonal, day-of-week, and other characteristics, and corrects the predicted power demand 30 by taking into account a consumption amount 34 (i.e., actual demand) by the power loads 15 in past feed-forward processes (step 300) to derive the electrical energy to be consumed by the power loads 15. The CEMS server 10 also collects, as the power generation amount 35, a history of a power generation amount from each power generation facility 16, and derives, by an arbitrary algorithm, generatable electrical energy that takes into account seasonal, weather, and other forecast information acquired from other servers. When a power generation amount enough to cover the electrical energy to be consumed by the power loads 15 cannot be obtained, the CEMS server 10 may add, to power supply to the power loads 15, electrical energy that should be purchased from the system 12 to make up the shortfall, i.e., a planned power purchase amount 37. Based on the supply and demand plan 31 created as described above, the CEMS server 10 derives an operation amount 32, i.e., planned operation amount to instruct each power load 15 to operate with scheduled electrical energy, and directs the planned operation amount to each power load 15. Note that, the power loads 15 may include the power generation facility 16 itself.

The CEMS server 10 performs the feed-back process in arbitrary cycles shorter than the feed-forward process, e.g., every one to several minutes. In the feed-back process, the CEMS server 10 performs feed-back compensation control (step 302) based on an actual power consumption record 33 by the power loads 15 (i.e., actual usage of an adjustment facility) and the power generation amount 35. The CEMS server 10 acquires the actual power consumption record 33 in the most recent feed-back process from the power loads 15 that have operated by operations with the planned operation amount. The CEMS server 10 also acquires the power generation amount 35 in the most recent feed-back process. The CEMS server 10 then corrects, using the actual power consumption record 33, electrical energy that can be consumed by the power loads 15 in the supply and demand plan 31 in the most recent feed-forward process, and corrects, using the power generation amount 35, electrical energy to be generated in the supply and demand plan 31 in the most recent feed-forward process. Based on the supply and demand plan 31 corrected as described above, the CEMS server 10 derives an operation amount 32, i.e., corrected operation amount to instruct each of the power loads 15 to operate with corrected electrical energy, and directs the corrected operation amount to each of the power loads 15.

The BM server 13 performs the adjustment process in arbitrary cycles shorter than the feed-forward process, e.g., every one to several minutes. In the adjustment process, the BM server 13 generates, based on the planned power purchase amount 37, an actual power purchase record 38, and the operation amount 32, a discharge instruction to cause the storage battery 14 to discharge power to be additionally supplied to the power loads 15, and sends out the discharge instruction to the storage battery 14. The planned power purchase amount 37 is an amount of power, which is derived in the most recent feed-forward process, to be further purchased from the system in order to be supplied to the power loads 15. The actual power purchase record 38 is a difference by which the consumption amount 34 exceeds the power generation amount 35. The BM server 13 corrects the planned power purchase amount 37 with the actual power purchase record 38 (step 304). When the power has been additionally purchased, the amount of the actual power purchase record 38 is added to the planned power purchase amount 37. The BM server 13 generates the discharge instruction, based on the planned power purchase amount 37 corrected as described above and the operation amount 32 generated in the feed-forward process, i.e., the planned operation amount, or, when corrected in the feed-back process, the corrected operation amount 32, i.e., the corrected operation amount. When the planned power purchase amount 37 is increased due to the actual power purchase record 38, the BM server 13 directs discharge of electrical energy corresponding to the increase. However, the electrical energy to be discharged can be equal to or less than an upper limit of the discharge of each storage battery 14. This makes it possible to contribute to the tracking of additional power supply while controlling degradation of the storage battery 14. The adjustment process may be configured to abort when the actual power purchase record 38 does not meet an arbitrary criterion.

When a large storage battery operation amount 39 is send out as the discharge instruction, the actual power consumption record 33 of power to be additionally supplied by discharge of the power generation facility 16 is updated and reflected in information in each of the adjustment process and feed-back process in the next cycle.

The feed-forward process, the feed-back process, and the adjustment process as described above are performed repeatedly.

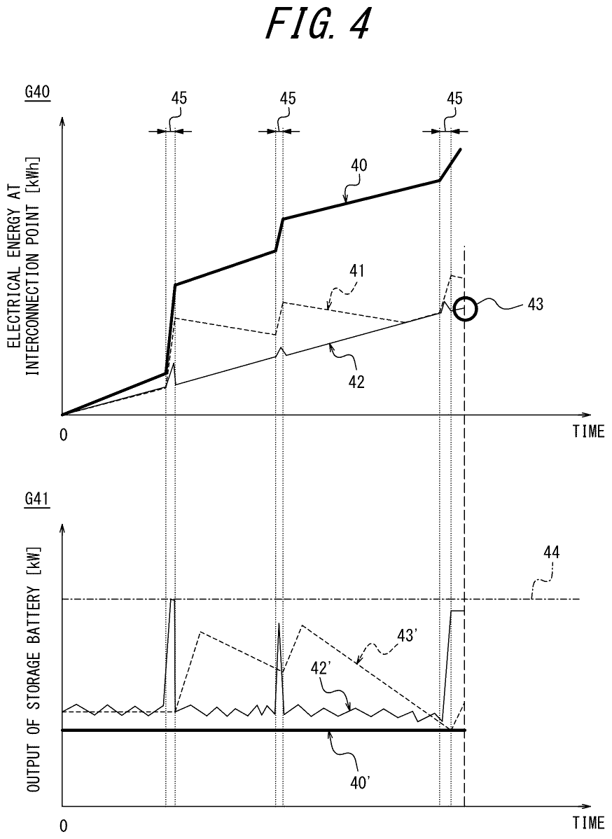

FIG. 4 is a diagram schematically illustrating power supply in the present embodiment. Graph G40 indicates cumulative electrical energy (vertical axis) at an interconnection point with the system 12, i.e., in the entire community 1, with a lapse of time (horizontal axis). Graph G41 indicates transition of output, i.e., the discharge amount (vertical axis) of the storage battery 14, with a lapse of time (horizontal axis). Graphs G40 and G41 indicate the cumulative electrical energy 40 and the discharge amount 40′ when the feed-forward process is performed, the cumulative electrical energy 41 and the discharge amount 41′ when the feed-back process is added, and the cumulative electrical energy 42 and the discharge amount 42′ when the adjustment process is added.

When the feed-forward process is performed, the cumulative electrical energy 40 illustrated in Graph G40 increases during time periods 45 in which sudden demand excess, for example, sudden increase in power demand or sudden decrease in power generation occurs, by increasing a power generation amount or a power purchase amount by tracking the demand excess (at this time, as illustrated in Graph G41, the output 40′ of the storage battery 14 is kept at zero). Therefore, the cumulative electrical energy 40 presents steady increase and is much higher than an initial planned power purchase amount 43.

When the feed-back process is added, the cumulative electrical energy 41 illustrated in Graph G40 increases by tracking the demand excess during the time periods 45, and then steadily decreases by tracking the actual power consumption record due to feed-back in the shorter cycles than the feed-forward process (in this case, as illustrated in Graph G41, the output 41′ of the storage battery 14 indicates the amount of discharge when the CEMS server 10 directs the operation amount 32 to the storage battery 14 in the feed-back process). However, the cumulative electrical energy 41 still exceeds the initial planned power purchase amount 43.

When the adjustment process is added, the cumulative electrical energy 42 illustrated in Graph G40 increases by tracking the demand excess in the time periods 45, and then converges to the planned power purchase amount 37 by tracking the actual power consumption record due to the adjustment process in the shorter cycles than the feed-back process. As illustrated in Graph G41, the discharge amount 42′ increases in the short term during the time periods 45. Then, the cumulative electrical energy 42 remains relatively stable and almost converges with the initial planned power purchase amount 43.

As described above, according to the present embodiment, it is possible to improve the tracking accuracy of additional power supply to meet fluctuations in power supply and demand in the community 1.

In a variation, the BM server 13 corrects a gain so that the discharge amount 42′ in the adjustment process decreases with a lapse of time. For example, as illustrated in Graph G41, the BM server 13 discharges the storage battery 14 up to an upper limit value 44 in the adjustment process in the first feed-back process, and decreases the gain in the adjustment process in the second feed-back process. This allows control of the rate of depletion and degradation of the storage battery 14.

In another variation, the BM server 13 may execute the adjustment process when the difference between the predicted power demand 30 and the actual power consumption record 33 is greater than an arbitrary criterion, e.g., greater than a criterion of 10 to 20% of the predicted power demand 30, and in other cases, i.e., when the difference between the predicted power demand 30 and the actual power consumption record 33 is relatively small, the BM server 13 may abort the execution of the adjustment process. This allows control of the rate of depletion and degradation of the storage battery 14, while ensuring a certain degree of tracking accuracy as a whole.

In the above embodiment, a processing/control program that specifies operations of the controller 23 of the BM server 13 may be stored in the memory 22 of the BM server 13 or in the memory of another server apparatus, and be downloaded onto each apparatus via the network 11. The processing/control program may also be stored on a non-transitory recording/storage medium readable by each apparatus, and each apparatus may read the program from the medium.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface; and
a controller configured to communicate by the communication interface with another server apparatus configured to direct a first operation amount to a power load in a jurisdiction to consume power that can be consumed by the power load, based on predicted power demand by the power load and an actual power generation record of an amount of power generated to be supplied to the power load, and change the first operation amount to a second operation amount based on an actual power consumption record consumed by the power load,
wherein the controller is configured to send out a discharge instruction to cause a storage battery to discharge power to be further supplied to the power load, based on a power purchase amount to be further purchased from a system in order to be supplied to the power load, the first operation amount, the actual power consumption record, and the actual power generation record, the power purchase amount being determined by the other server apparatus.

2. The server apparatus according to claim 1, wherein the controller is configured to send out the discharge instruction in a second cycle that is shorter than a first cycle in which the first operation amount is changed to the second operation amount in the other server apparatus.

3. The server apparatus according to claim 2, wherein in the other server apparatus, the first operation amount is directed to the power load in a second cycle longer than the first cycle.

4. The server apparatus according to claim 1, wherein the controller is configured to perform, when sending out the discharge instruction, correction to make a discharge amount to be discharged from the storage battery smaller.

5. The server apparatus according to claim 4, wherein the controller is configured to perform correction to make a discharge amount at a second time point after a first time point smaller than a discharge amount at the first time point.

6. A power control system having a plurality of server apparatuses configured to be communicably connected, the power control system comprising:
a first server apparatus configured to direct a first operation amount to a power load in a jurisdiction to consume power that can be consumed by the power load, based on predicted power demand by the power load and an actual power generation record of an amount of power generated to be supplied to the power load, and change the first operation amount to a second operation amount based on an actual power consumption record consumed by the power load; and
a second server apparatus configured to send out a discharge instruction to cause a storage battery to discharge power to be further supplied to the power load, based on a power purchase amount to be further purchased from a system in order to be supplied to the power load, the first operation amount, the actual power consumption record, and the actual power generation record, the power purchase amount being determined by the first server apparatus.

7. The power control system according to claim 6, wherein the second server apparatus is configured to send out the discharge instruction in a second cycle that is shorter than a first cycle in which the first operation amount is changed to the second operation amount in the first server apparatus.

8. The power control system according to claim 7, wherein in the first server apparatus, the first operation amount is directed to the power load in a second cycle longer than the first cycle.

9. The power control system according to claim 6, wherein the second server apparatus is configured to perform, when sending out the discharge instruction, correction to make a discharge amount to be discharged from the storage battery smaller.

10. The power control system according to claim 9, wherein the first server apparatus is configured to perform correction to make a discharge amount at a second time point after a first time point smaller than a discharge amount at the first time point.

11. A power control method by a plurality of server apparatuses configured to be communicably connected, the power control method comprising:
directing, by a first server apparatus, a first operation amount to a power load in a jurisdiction to consume power that can be consumed by the power load, based on predicted power demand by the power load and an actual power generation record of an amount of power generated to be supplied to the power load;
changing, by the first server apparatus, the first operation amount to a second operation amount based on an actual power consumption record consumed by the power load; and
sending out, by a second server apparatus, a discharge instruction to cause a storage battery to discharge power to be further supplied to the power load, based on a power purchase amount to be further purchased from a system in order to be supplied to the power load, the first operation amount, the actual power consumption record, and the actual power generation record, the power purchase amount being determined by the first server apparatus.

12. The power control method according to claim 11, wherein the second server apparatus is configured to send out the discharge instruction in a second cycle that is shorter than a first cycle in which the first operation amount is changed to the second operation amount in the first server apparatus.

13. The power control method according to claim 12, wherein in the first server apparatus, the first operation amount is directed to the power load in a second cycle longer than the first cycle.

14. The power control method according to claim 11, wherein the second server apparatus is configured to perform, when sending out the discharge instruction, correction to make a discharge amount to be discharged from the storage battery smaller.

15. The power control method according to claim 14, wherein the first server apparatus is configured to perform correction to make a discharge amount at a second time point after a first time point smaller than a discharge amount at the first time point.
